(19) United States
(12) Patent Application Publication
(10) Pub. No.: US 2006/0053592 A1
(43) Pub. Date: Mar. 16, 2006

(54) Ice cream holder

(76) Inventor: Aniello Costagliola, Easton, MD (US)

Correspondence Address: Robert DeWitty;c/o Outsource Product Manufacture LLC, Ste. 2700, 111 S. Calvert Street, Baltimore, MD, 21202, US

(21) Appl. No.: 10/938,646

(22) Filed: Sep. 13, 2004

(51) Int. Cl. B25G 1/00

(52) U.S. Cl. 16/430; 425/269

(57) ABSTRACT

The invention relates to an ergonomic handle comprising a base with an appendage extending therefrom. The handle is suitable for reducing the pressure on the wrist on tool operators, thereby decreasing occurrences of carpal tunnel syndrome. The scooping device handle is suitable for fitting into standard scoop holders and retail environments.

### BACKGROUND

In retail environments, frozen edible substances, such as ice cream, sorbet, sherbet, and the like, are usually dispersed from bulk containers using scooping devices. The devices usually consist of a handle, attached to a spherical, concave bowl. The method of scooping relies upon pressure exerted by the wrist against the frozen substance. In the event the frozen substance is extremely hard, such as when it is first brought out of the freezer, the method of scooping can create an undo and harmful amount of stress on the wrist.

Carpal tunnel syndrome is a common condition of the hand caused by swelling of the synovial membrane, tendon inflammation, and any condition that reduces the available space in the carpal tunnel. Activities that cause flexion of the wrist and fingers, such as repetitive and forceful grasping of the hands, and repetitive bending of the wrist, are common causes of the carpal tunnel syndrome. Specifically, these symptoms are caused when a dense fibrous tissue called the traverse carpal ligament forms over and compresses the median nerve. Common symptoms of the condition include pain and numbness of the hand.

In the field of scooping devices, for frozen edible foods, several inventions have attempted to address the issue of stress on the wrist; The patent to Wanderer (U.S. Pat. No. 5,368,465) relates to an ice cream scoop designed to alleviate strain on the operators wrist, and to provide support and stability to the wrist. This is done by attaching a forearm appendage to a scoop device. While addressing the issue of carpal tunnel syndrome, it is believed that, because of the additional attachment required in the invention, such invention would be much more expensive than current scoop devices in the market. Further, the additional attachment would likely not allow the scoop to fit into standard scoop holders (as present in most retail environments).

Other patents, while not specifically drawn to scoop devices, have attempted to address carpal tunnel syndrome by designing handles. The patent to Ballone et al. (U.S. Pat. No. 4,488,460) relates to an ergonomic handle to reduce operator fatigue over extended use of the tool. The handle has an elliptical cross-section taken in the first plane passing through the center of the body and inclined with respect to the axis of the shank means. While attempting to address the issue of operator fatigue, it is believed this type of handle would not be suitable for a scooping device as the size if the handle would compromise the ability to scoop significant portions of ice cream. The patent to Dalvry (U.S. Pat. No. 5,692,265) relates to an ergonomic handle shaped to encourage a relevant working grip, thereby increasing user comfort and control.

Despite the advances in scooping devices and handles, there remains a need for a scooping device handle that is ergonomic, inexpensive to product, and suitable for fitting into standard scoop holders and retail environments.

### SUMMARY

The present invention provides a handle that allows for a reduction in pressure of the wrist of the operator.

Another object of this invention is to provide a scooping device possessing an ergonomic handle that is suitable for fitting into standard scoop holders.

Still yet, another object of this invention is to provide a scooping device that is relatively inexpensive to produce in comparison to other scoops.

The exact nature of this invention as well as other objects will be readily apparent from consideration of the specification, including the drawings. Those of skill in the art will appreciate that the invention described herein is susceptible to many modifications and variations without departing from its scope.

### BRIEF DESCRIPTION OF DRAWINGS

FIG. 1 is a top, plan view of the handle.

FIG. 2 is a right-sided view of the handle.

FIG. 3 is a rear view of the handle.

FIG. 4 shows the handle connected to a scooping device.

FIG. 5 shows the handle connected to a gardening tool.

FIG. 6 is an undercarriage view of the handle.

### DETAILED DESCRIPTION OF THE PREFERRED EMBODIMENT

The invention is an ergonomic handle comprising a base with an appendage extending therefrom. The handle is suitable for reducing the pressure on the wrist on tool operators, thereby decreasing occurrences of carpal tunnel syndrome.

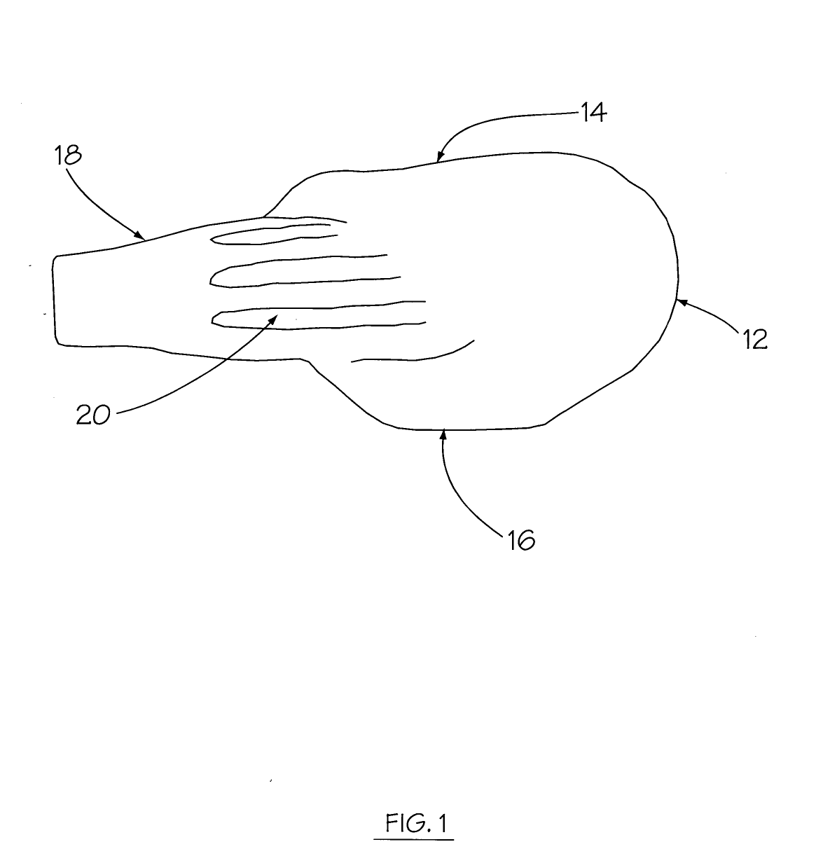

With reference to FIG. 1, the handle (10) has an oval-shaped base portion (12) possessing a substantial convex portion (14) on one side of the base and a slightly concave portion (16) on the other side. Extending from the base (10) is an appendage (18). In a preferred embodiment, the appendage contains grooves (20). Most preferably, the grooves (20) are equidistant from each other to provide maximum grip.

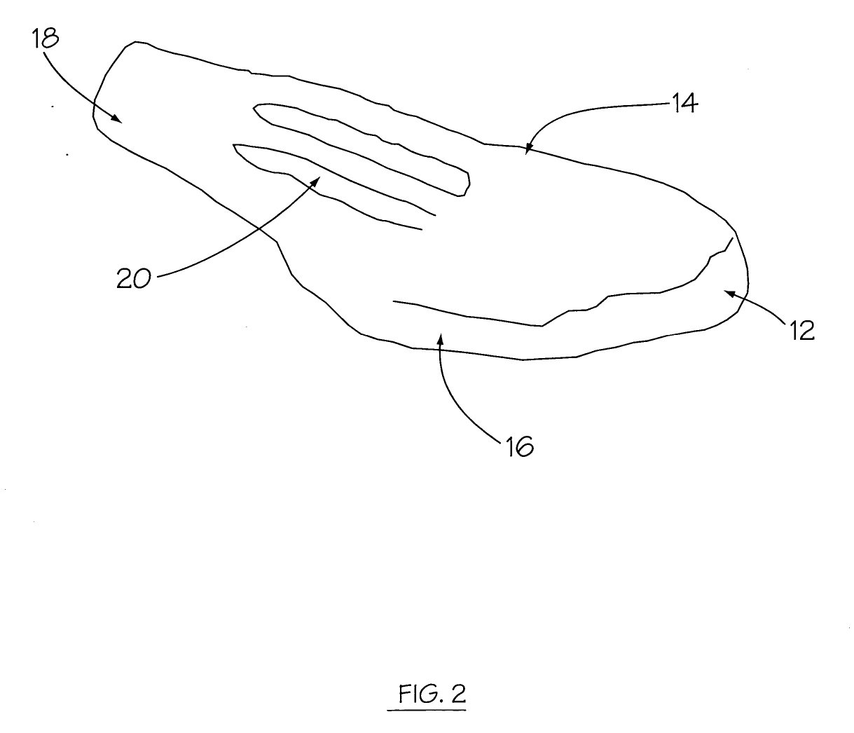

Referring to FIG. 2, showing the handle at the right side, it can be seen that the appendage (18) extends from the base (10) at an angle to the x-axis. In a preferred embodiment, the appendage (18) can be angled from about 5° to 35° to the x-axis. More preferably, the appendage (18) is from about 2° to 30° to the x-axis. Most preferably, the appendage (18) is angled from 25° to 29°.

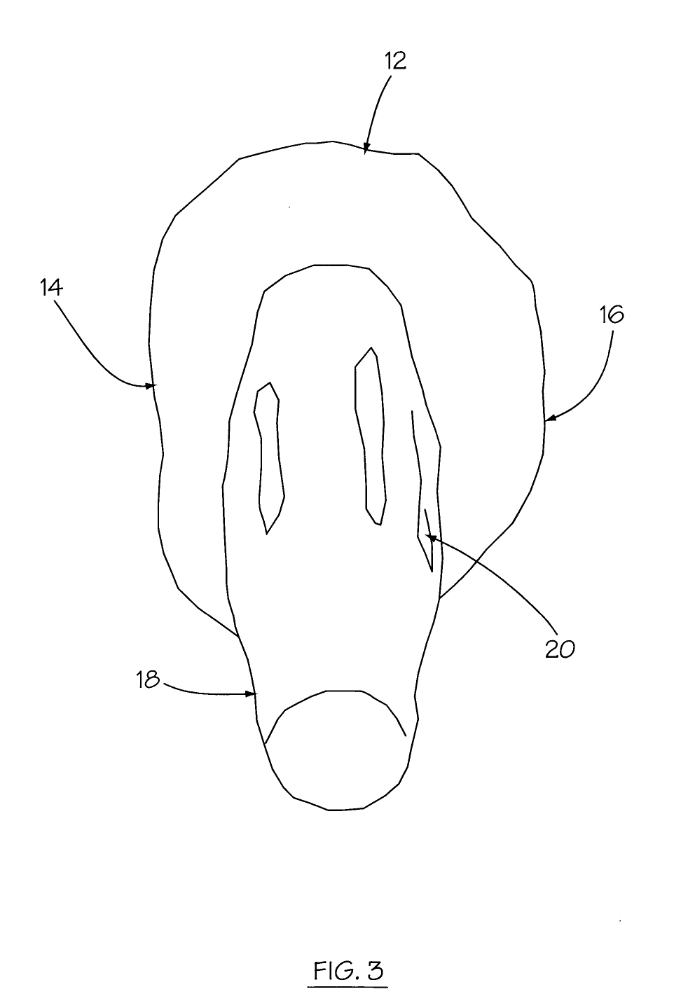

Referring to FIG. 3, showing the rear of the handle (10), it can be seen the appendage (18) is positioned bearing to the right of the y-axis. Preferably, the appendage (18) bears to the right from about 1° to 5° from the y-axis.

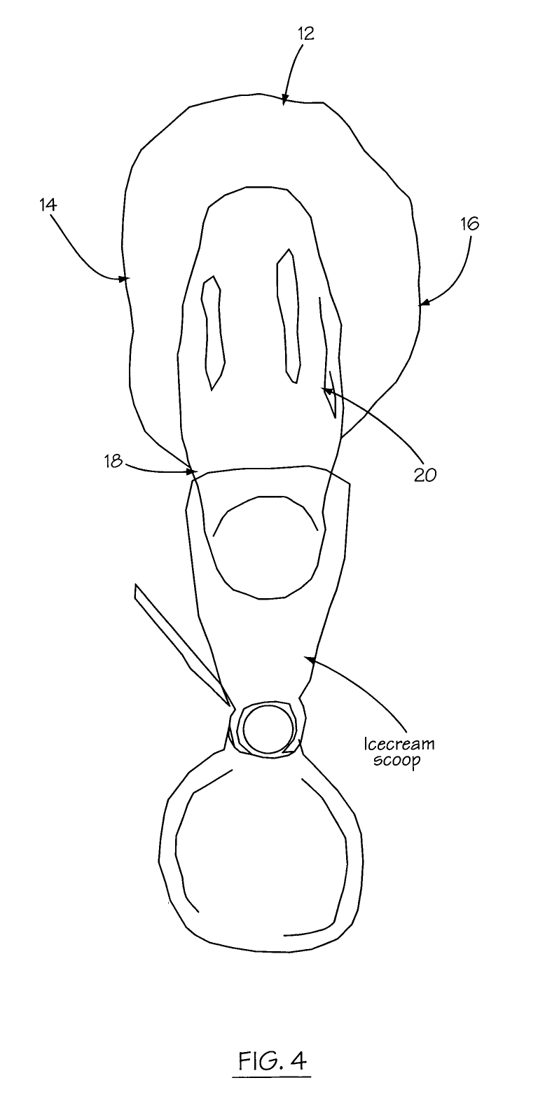

Referring to FIG. 4, (this drawing should show the handle connected to an ice cream scope) the handle (10) is shown connected to a scooping device (22).

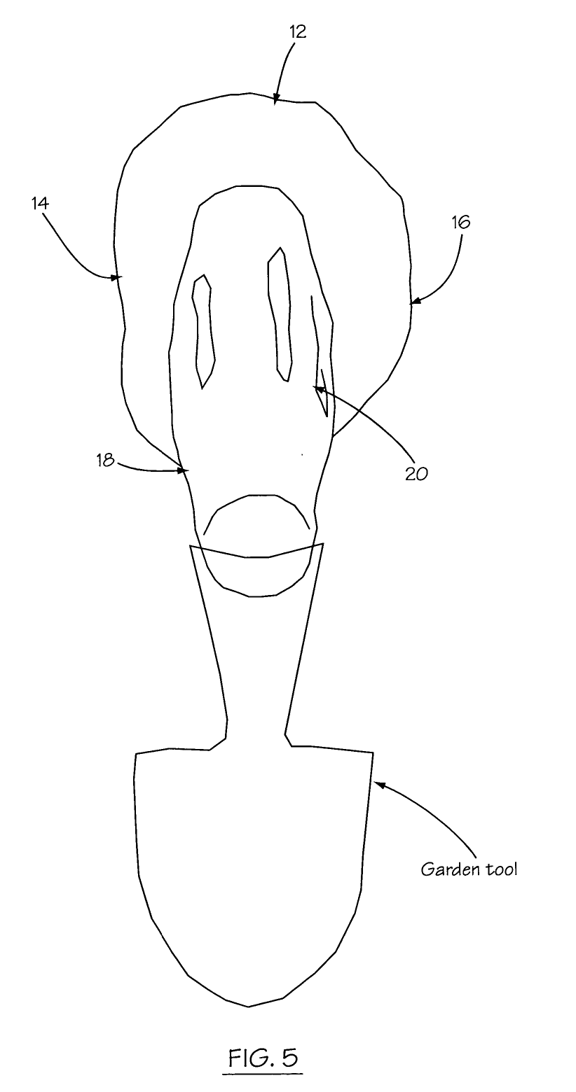

Referring to FIG. 5, (this drawing should show the handle connected to a tool) the handle is shown connected to a gardening tool (24).

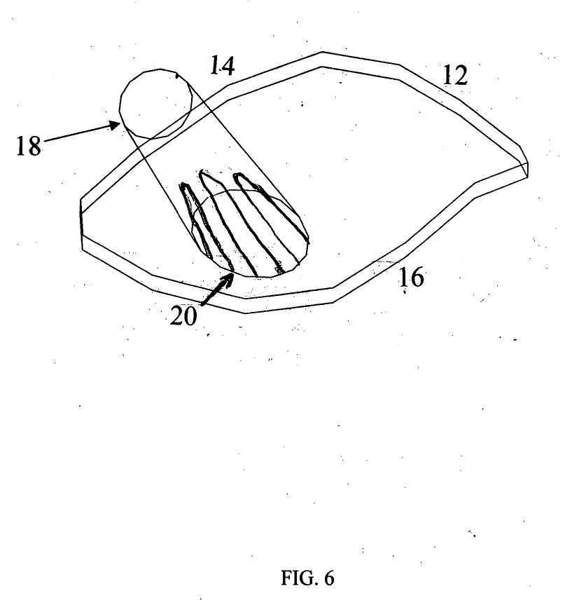

Referring to FIG. 6, the undercarriage of the handle is shown to be slightly concave. In this way the handle more neatly fits in the palm of the hand.

In a preferred embodiment, the handle consists of a base that contains a convex portion (14) from about 1 inch to 2⅜ inch in length and a concave portion from about 2 inches to about 2¾ inches in length. The base (10) is from about 1.5 inches to 2 inches in width. The appendage 918) is from 0.5 inch to 1.5 inches in diameter, and from 2 inches to 3 inches in length.

Many modifications and varieties of the present invention are possible, and will be evident to those of ordinary skill in the art. For example, the handle may be constructed from a metallic material, or the handle may be constructed from a variety of synthetic plastics.

Further, the invention is suitable for use by both left-hand and right-hand grips.

1. An ergonomic handle comprising an oval-shaped base having a convex side and a concave side, an undercarriage that is slightly concave, and an appendage extending from said base, wherein said base is from about 1 inch to 2.5 inches in width:

2. The ergonomic handle of claim 1, wherein the base is from about 2 inches to about 3.5 inches in length.

3. The ergonomic handle of claim 1, wherein the appendage extends from the base at an angle from 5° to 35°.

4-5. (canceled)

6. An ice cream scooping device comprising an oval-shaped base having a convex side and a concave side, an undercarriage that is slightly concave, an appendage extending from said base, and a scooping means attached to the appendage, wherein said base is from about 1 inch to 2.5 inches in width.

7. A tool handle comprising an oval-shaped base having a convex side and a concave side, an undercarriage that is slightly concave and an appendage extending from said base, wherein said base is from about 1 inch to 2.5 inches in width.
